(19) United States
(12) Patent Application Publication
(10) Pub. No.: US 2015/0189336 A1
(43) Pub. Date: Jul. 2, 2015

(54) METHOD AND APPARATUS FOR VIDEO SERVICE TRANSMISSION

(71) Applicant: Alcatel Lucent, Boulogne Billancourt (FR)

(72) Inventors: He Wang, Shanghai (CN); Hua Chao, Shanghai (CN)

(73) Assignee: Alcatel Lucent, Boulogne Billancourt (FR)

(21) Appl. No.: 14/414,920

(22) PCT Filed: Jul. 1, 2013
(86) PCT No.: PCT/IB2013/001643

§ 371 Date: Jan. 15, 2015

(30) Foreign Application Priority Data
Jul. 16, 2012 (CN) 201210246441.0

(51) Int. Cl. H04N 21/2383; H04N 13/00; H04N 21/61; H04N 19/31; H04N 21/6437; H04N 21/6405

(52) U.S. Cl. CPC H04N 21/2383; H04N 21/6437; H04N 21/6405; H04N 21/6131; H04N 19/31; H04N 13/0048

(57) ABSTRACT

The invention proposes a method and apparatus of video service transmission. A method of managing video service transmission in a broadcast multicast service center is proposed, wherein, the video service is coded as base coding layer data and enhancement coding layer data, the base coding layer data and the enhancement coding layer data respectively use different multimedia broadcast multicast service bearer to implement transmission, the method comprises the following steps: obtaining dependency information of the enhancement coding layer data, the dependency information being used to indicate the coding layer data on which the enhancement coding layer data depends; and transmitting to a multimedia broadcast multicast service gateway a session start request signaling of multimedia broadcast multicast service, the session start request signaling of multimedia broadcast multicast service being used to request establishing multimedia broadcast multicast service bearer for the enhancement coding layer data, the session start request signaling of multimedia broadcast multicast service including the dependency information.

### TECHNICAL FIELD

The invention relates to wireless communication system, especially relates to bearer management in wireless video communication.

### BACKGROUND OF THE ART

With the rapid development of mobile video service, wireless video applications will become very popular applications in the near future. In a wireless network, the video service provision will face various wireless channel conditions and receivers with different capabilities. So the same video service must be adjusted to provide proper quality to different users under different transmission environments. In order to solve the problem, the scalable video coding (SVC) provides one video service with multiple coding layers, and the video service is coded as one base layer (BL) and one or multiple enhancement layers (EL). SVC supports different scalable dimensions, such as space, time and quality. On the other hand, in the recent years 3D video service also becomes more and more popular. The multi-view video coding (MVC) used for stereo video as the extension of H.264 codec technology may also be seen as a scalable coding among different views. A MVC stereo video service usually comprises a base view and one or multiple non-base view. Thus, the wireless video service based on scalable coding will be more and more dominant in the future.

### SUMMARY OF THE INVENTION

The invention proposes a method and apparatus of MBMS bearer management used for video service transmission of wireless scalable coding.

According to a first aspect of the invention, a method used for managing video service transmission in a broadcast multicast service center is provided, wherein, the video service is coded as base coding layer data and enhancement coding layer data, the base coding layer data and the enhancement coding layer data respectively use different multimedia broadcast multicast service bearer to implement transmission, the method comprises the following steps: obtaining dependency information of the enhancement coding layer data, the dependency information being used to indicate the coding layer data on which the enhancement coding layer data depends; and transmitting to a multimedia broadcast multicast service gateway a session start request signaling of multimedia broadcast multicast service, the session start request signaling of multimedia broadcast multicast service being used to request establishing multimedia broadcast multicast service bearer for the enhancement coding layer data, the session start request signaling of multimedia broadcast multicast service including the dependency information.

According to a second aspect of the invention, a method used for managing video service transmission in a network device is provided, wherein, the video service is coded as base coding layer data and enhancement coding layer data, and the method comprises the following steps: obtaining a first session start request signaling of multimedia broadcast multicast service from an upstream network device, the first session start request signaling of the multimedia broadcast multicast service being used to request establishing multimedia broadcast multicast service bearer for the enhancement coding layer data, the first session start request signaling of multimedia broadcast multicast service including dependency information, and the dependency information being used to indicate the coding layer data on which the enhancement coding layer data depends; determining whether the multimedia broadcast multicast service bearer, for the coding layer data on which the enhancement coding layer data depends, is successfully established; and when the multimedia broadcast multicast service bearer for the coding layer data on which the enhancement coding layer data depends is successfully established, forwarding the first session start request signaling of multimedia broadcast multicast service to a downstream network device of the network device; when the multimedia broadcast multicast service bearer for the coding layer data on which the enhancement coding layer data depends is not successfully established, suspending forwarding the first session start request signaling of multimedia broadcast multicast service to the downstream network device.

According to a third aspect of the invention, a method used for managing video service transmission in a base station is provided, wherein, the video service is coded as base coding layer data and enhancement coding layer data, and the method comprises the following steps: obtaining a first session start request signaling of multimedia broadcast multicast service from a multicast coordination entity, the first session start request signaling of multimedia broadcast multicast service being used to request establishing multimedia broadcast multicast service bearer for the enhancement coding layer data, the first session start request signaling of multimedia broadcast multicast service including dependency information, and the dependency information being used to indicate the coding layer data on which the enhancement coding layer data depends; determining whether the multimedia broadcast multicast service bearer for the coding layer data on which the enhancement coding layer data depends is successfully established; and when the multimedia broadcast multicast service bearer for the coding layer data on which the enhancement coding layer data depends is successfully established, storing identification information that the multimedia broadcast multicast service bearer for the enhancement coding layer data is successfully established; when the multimedia broadcast multicast service bearer for the coding layer data on which the enhancement coding layer data depends is not successfully established, storing the identification information that the multimedia broadcast multicast service bearing for the enhancement coding layer data is not successfully established; and transmitting a feedback of unsuccessfully establishing the multimedia broadcast multicast service bearer for the enhancement coding layer data, to the multicast coordination entity.

According to a fourth aspect of the invention, a first apparatus used for managing video service transmission in a broadcast multicast service center is provided, wherein, the video service is coded as base coding layer data and enhancement coding layer data, the base coding layer data and the enhancement coding layer data respectively use different multimedia broadcast multicast service bearer to implement transmission, and the first apparatus comprises the following modules: a first obtaining module, used for obtaining dependency information of the enhancement coding layer data, the dependency information being used to indicate the coding layer data on which the enhancement coding layer data depends; and a first transmitter module, used for transmitting to a multimedia broadcast multicast service gateway a session start request signaling of multimedia broadcast multicast service, the session start request signaling of multimedia broadcast multicast service being used to request establishing multimedia broadcast multicast service bearer for the enhancement coding layer data, and the session start request signaling of multimedia broadcast multicast service including the dependency information.

According to a fifth aspect of the invention, a second apparatus used for managing video service transmission in a network device is provided, wherein, the video service is coded as base coding layer data and enhancement coding layer data, and the second apparatus comprises the following modules: a second obtaining module, used for obtaining a first session start request signaling of multimedia broadcast multicast service from an upstream network device, the first session start request signaling of multimedia broadcast multicast service being used to request establishing multimedia broadcast multicast service bearer for the enhancement coding layer data, the first session start request signaling of the multimedia broadcast multicast service including dependency information, and the dependency information being used to indicate the coding layer data on which the enhancement coding layer data depends; a first determining module, used for determining whether the multimedia broadcast multicast service bearer for the coding layer data on which the enhancement coding layer data depends is successfully established; and a second transmitter module, used for, when the multimedia broadcast multicast service bearer for the coding layer data on which the enhancement coding layer data depends is successfully established, forwarding the first session start request signaling of multimedia broadcast multicast service to a downstream network device of the network device; when the multimedia broadcast multicast service bearer for the coding layer data on which the enhancement coding layer data depends is not successfully established, the second transmitter module suspends forwarding the first session start request signaling of multimedia broadcast multicast service to the downstream network device.

According to a sixth aspect of the invention, a third apparatus used for managing video service transmission in a base station is provided, wherein, the video service is coded as base coding layer data and enhancement coding layer data, and the third apparatus comprises the following modules: a third obtaining module, used for obtaining a first session start request signaling of multimedia broadcast multicast service from a multicast coordination entity, the first session start request signaling of multimedia broadcast multicast service being used to request establishing multimedia broadcast multicast service bearer for the enhancement coding layer data, the first session start request signaling of multimedia broadcast multicast service including dependency information, and the dependency information being used to indicate the coding layer data on which the enhancement coding layer data depends; a second determining module, used for determining whether the multimedia broadcast multicast service bearer for the coding layer data on which the enhancement coding layer data depends is successfully established; and a storing module, used for storing identification information that the multimedia broadcast multicast service bearer for the enhancement coding layer data is successfully established, when the multimedia broadcast multicast service bearer for the coding layer data on which the enhancement coding layer data depends is successfully established; when the multimedia broadcast multicast service bearer for the coding layer data on which the enhancement coding layer data depends is not successfully established, the storing module is used for storing the identification information that the multimedia broadcast multicast service bearer for the enhancement coding layer data is not successfully established; and the third apparatus further includes a feedback module, which is used for transmitting a feedback of unsuccessfully establishing the multimedia broadcast multicast service bearer for the enhancement coding layer data, to the multicast coordination entity.

Using the solution of embodiments of the invention, the network devices of each level in the path of MBMS session start/stop have the bearer management function of scalable coding video service or multiple video coding service, which thus ensures BL MBMS bearer service and EL MBMS bearer service to be established and released correctly and effectively.

Besides, embodiments of the invention indicates the dependency relation between BL MBMS service and EL MBMS service of scalable coding video service in a MST transmission in a simple and effective way. The dependency relation may be used by eNodeB for optimization based on QoE, thus better adapting time-variant wireless channel conditions, environments, and improving eNodeB processing capability, and providing higher QoE wireless video transmission service.

### BRIEF DESCRIPTION OF THE DRAWINGS

By reading the following detailed description for unlimited embodiments referring the attached diagrams, other features, purposes, advantages of the invention will be clearer.

FIG. 1 shows the MBMS session start procedure in the evolved packet system, to establish MBMS bearer service.

FIG. 2 shows the diagram of the network topology.

FIG. 3 shows the flow chart managing the MBMS bearer establishing for scalable coding video service in the network devices of each level.

FIG. 4 and FIG. 5 show the related signaling process managing the MBMS bearer release for a scalable coding video in a BMSC according to an embodiment of the invention.

FIG. 6 shows the related signaling process managing the MBMS bearer releasing for scalable coding video in a BMSC according to another embodiment of the invention.

FIG. 7 shows the block diagram of the first apparatus according to an embodiment of the invention.

FIG. 8 shows the block diagram of the second apparatus according to an embodiment of the invention.

FIG. 9 shows the block diagram of the third apparatus according to an embodiment of the invention.

Wherein, the same or similar diagram marks show the same or similar step features or apparatuses/modules.

### DETAILED EMBODIMENTS

For the scalable coding video service, different coding layers of the same service have correlation, and have different degrees of importance for decoding of the reconstruction for original video, which will affect the quality of experience (QoE). The BL data is the most important data for video decoding and must be correctly received at first. The BL data may be separately used for the video decoding with a basic acceptable quality, and also may be used together with the EL for a higher quality.

Besides, the scalable coding video transmission defines two transmission modes, namely multi-session transmission (MST) and single session transmission (SST). For a MST, different scalable coding layers data are transmitted on different RTP (real-time transport protocol) sessions. MST is usually used in broadcast and multicast transmission of video service. A SVC video transmission generally comprises multiple RTP sessions. In the MST transmission mode, different video coding layers may be mapped to different RTP transmission streams. Especially, the BL data will construct a separate RTP stream, and other EL data will construct one or more RTP streams. The MST is used in broadcast and/or multicast transmission scenario, and it is transmitted via MBMS bearer.

In the current MBMS architecture, the broadcast-multicast service centre (BMSC) will initiate different MBMS services for these BL and EL data streams. One RTP stream will be mapped to one MBMS service in one BMSC. This means that, for a scalable coding wireless video service using the MST transmission mode, the BMSC will initiate multiple different MBMS services for these different coding layer data.

It can be seen that these EL MBMS services of the same video service depend on the BL of the video service. The dependency information also may be used to provide the service of differentiated quality by a radio access network, which is necessary for optimizing the scalable coding video transmission based on QoE.

Based on the above analysis, for a scalable coding video service, it needs to set a timing requirement for the MBMS bearer establishment for the BL MBMS service and EL MBMS service, since the EL data is valid only after the BL data is correctly received. Thus, if the BL MBMS bearer service isn't successfully established, there is no need to establish other EL MBMS bearer service of the SVC video service corresponding to the BL data. Besides, there is a similar requirement for the release procedure of the related MBMS bearer service.

In the following specification, the term “base layer data” includes the BL MBMS service in a SVC structure, also includes the base view of multi-view coding. The term “enhanced layer data” includes the EL MBMS service in a SVC structure, also includes the non-base view of multi-view coding. In the specification, we take the BL MBMS service (short for BL) and the EL MBMS service (short for EL) in scalable video coding (SVC) service as an example to elucidate the invention. But, those skilled in the art may completely understand that embodiments of the invention are also suitable for base view and non-base view of multi-view video coding (MVC), and suitable for other data transmission with mutual dependency relation.

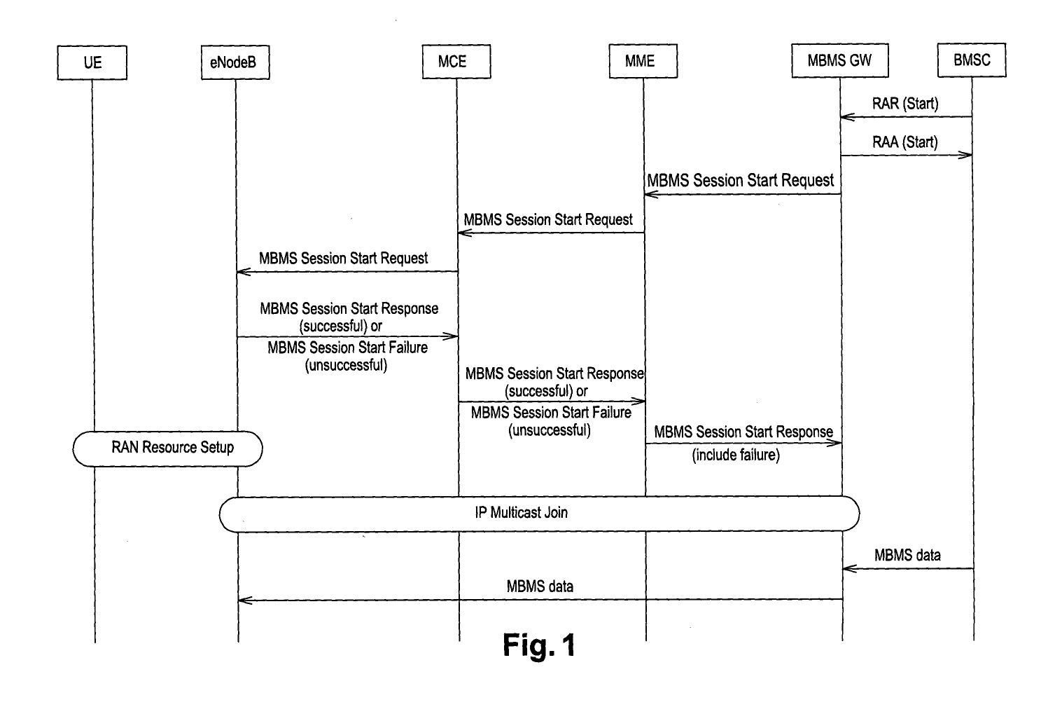

According to the current protocol, a MBMS session start or stop procedure is used to establish or release MBMS bearer service respectively. FIG. 1 shows a MBMS session start procedure in an evolved packet system (EPS) to establish MBMS bearer service. First, the BMSC transmits a RAP (re-auth-request) message to the MBMS GW to initiate a MBMS service transmission and provide the corresponding session attribute. The MBMS GW feeds back a RAA (re-auth-answer) message to the BMSC. Then the MBMS GW initiates the MBMS session start request to a MME (mobility management entity), then the MME forwards the MBMS session start request to a MCE (multicast coordination entity). Then the MCE forwards the MBMS session start request to an eNodeB. Next, the eNodeB feeds back the MBMS session start response to the MCE, including whether it's successful, that's, if the eNodeB and the BMSC successfully establishes a bearer, feeding back a success indication; if the eNodeB and the BMSC do not successfully establish a bearer, feed back a failure indication. Then the MCE forwards the MBMS session start response to the MME. Next the MME forwards the MBMS session start response to the MBMS GW. After the eNodeB and the BMSC successfully establish a bearer, the eNodeB and a UE establish radio access network (RAN) resource. Then an IP multicast join process between the MBMS GW and the eNodeB is implemented to form a multicast tree. Next the BMSC transmits MBMS data to the MBMS GW, and the MBMS GW forwards MBMS data to the eNodeB.

In the process, some network devices may feed back MBMS session start failure. E.g. a base station and multicast coordination entity feed back MBMS session start failure, which is used for indicating a failure in request of the MBMS session start. This means that for these network devices, the MBMS session start is unsuccessful, and the corresponding MBMS bearer is not established. If the BL MBMS service has an event of failure in request of the MBMS session start, the EL MBMS service bearer corresponding to the BL shouldn't be established in these network devices.

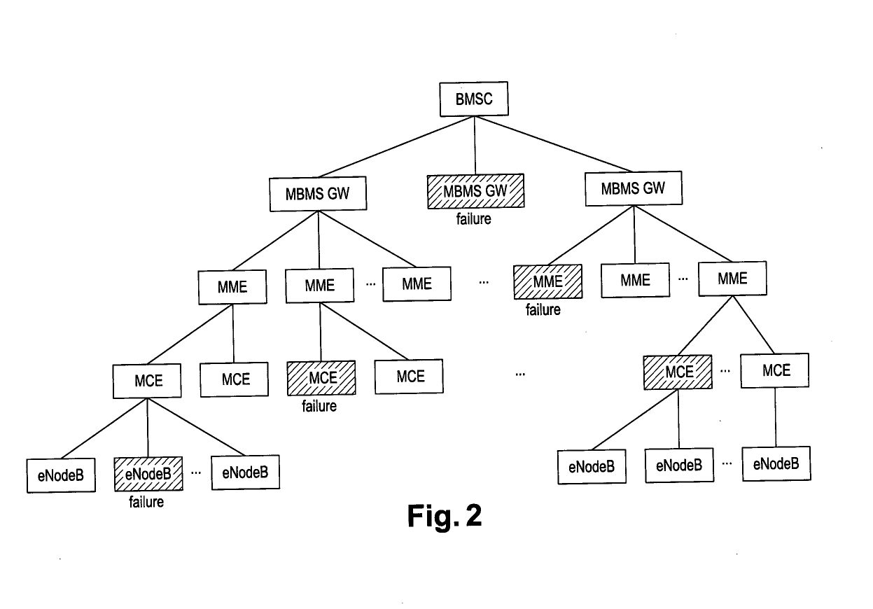

On the other hand, for the MBMS bearer service, there are multiple downstream network devices under a BMSC control. From the perspective of a whole network structure, the network topology may be illustrated as a tree structure, shown as FIG. 2. The BMSC is similar to a root node, and the eNodeB is similar to a leaf node. Each network device level except the BMSC may have a failure of the MBMS session start procedure, which leads to that the MBMS bearer service is unsuccessfully established. E.g., in FIG. 2, the oblique line shows the eNodeB, MCE, MME and MBMS GW with a failure in the MBMS session start procedure. For the scalable video service using MST transmission, it needs to guarantee that the MBMS bearer resource corresponding to a scalable video service is managed correctly and efficiently.

Once a session start failure happens to the BL MBMS bearer service in some network devices, it needs to prevent the subsequent establishment of the related EL MBMS bearer service. Otherwise, if the MBMS bearer of the BL MBMS service is established unsuccessfully, it still establishes the MBMS bearer for the related EL MBMS service, which leads to a waste of wireless bearer resource. But when the MBMS bearer of some network devices is established unsuccessfully, it will not affect the establishment of the MBMS bearer of other network devices to provide a scalable video service. Thus, it needs to define a proper management mechanism in each network device from a BMSC to an eNodeB to guarantee the BL MBMS bearer service and the related EL MBMS bearer service are established correctly and efficiently.

Furthermore, the radio access network faces the challenge of implementing optimization for scalable video services due to time-variant wireless channel conditions, environments and instant available radio resources with the consideration of QoE. Thus, it needs to provide flexible bit-stream adaptation and error robustness according to different importance of actual data (e.g. the BL is more important than the EL for the QoE of a video user). E.g. by using intelligent rate adaptation in an eNodeB, according to different importance of actual data, the eNodeB actively drops packets, e.g. abandoning part EL data or non-base view. To implement the above optimization for QoE, the eNodeB needs to know other information of the scalable video coding, such as the dependency information of different coding layers. Now only the application layer in BMSC knows the above information, but the above information is not visible to the radio access network.

In embodiments of the invention, the method and apparatus of MBMS bearer management of scalable video services are proposed in broadcast/multicast architecture based on MST transmission, in network devices such as from BMSC to eNodeB. It may guarantee that the MBMS bearer resource corresponding to a scalable video service is managed correctly and efficiently. Besides, if some network devices fails to establish some BL MBMS bearer, through the solution of embodiments of the invention, it will have little impact on other network devices in the service area (SA), thus to the providing of scalable video services continues. According to the solution of embodiments of the invention, the dependency relation between the BL MBMS service and the related EL MBMS service is simply and efficiently expressed in the corresponding signaling, and may be transmitted from the BMSC to the eNodeB. The signaling may be used by the eNodeB to implement optimization to the process with consideration of QoE.

Currently there is no bearer management solution used for the scalable video transmission and optimization in the network devices from a BMSC to an eNodeB. There is also no indication from a BMSC to an eNodeB via a standard interface signaling to describe the dependency relation between the BL MBMS service and the EL MBMS service used for scalable video services.

The MST transmission used for scalable video services is defined in a broadcast/multicast mode in the MBMS architecture. Different encoding layers of a scalable video may generate multiple RTP streams, and be mapped to different MBMS services of the BMSC. Especially, the BL data needs a separate MBMS service, and the EL data needs other MBMS services. Currently the BMSC initiates the corresponding bearer resource establishing/release process via a session start/stop procedure.

As the entrance of a scalable video service, the BMSC make the scalable video service enter an EPS network. The BMSC may obtain detailed application information, e.g. the dependency information of scalable video coding, from external applications, such as an application server. Thus, the BMSC knows the dependency relation information between the BL MBMS service and the EL MBMS service. But in order to achieve the bearer management function in other network devices along the session start/release procedure path, such as a MBMS GW, a MME, a MCE and an eNodeB, these network devices also need to know the dependency relation information between the BL MBMS service and the EL MBMS service.

Thus, embodiments of the invention first will solve how to indicate the dependency relation information between the BL MBMS service and the EL MBMS service of a scalable video service, and transmit it from the BMSC to the eNodeB through middle network devices. The information should be used by all related network devices in their respective bearer management function, in order to be used for the scalable video transmission. The information may also be used for the subsequent further QoE optimization operation by the eNodeB.

The BMSC uses the session start/stop procedure to trigger the related MBMS bearer establishment/release. In the process of the MBMS session start signaling, the BMSC will transmit the service session attributes, such as a temporary mobile group identifier (TMGI), a flow identifier, QoS, the MBMS service area, a session identifier, estimated session duration, the list of MBMS control plane nodes of the MBMS GW (comprising MME, serving GPRS support node (SGSN)), MBMS data transmission time, MBMS data transmission start, access identifier etc. Wherein, the TMGI is used to distinguish different MBMS services. That's, the TMGI is the only identifier for each MBMS service. The BMSC is responsible for allocating a TMGI to each MBMS service. Thus, for a scalable video service, the BL data service and the EL data service have different TMGIs. Different BL data services of different scalable video services also have different TMGIs to distinguish.

The dependency relation information between the BL MBMS service and the EL MBMS service not only comprises the dependency relation between the EL and the BL, but also comprises the dependency relation between the EL and other different ELs. Since some EL decoding depends on the BL and other ELs. E.g. in a scalable video service, there are a BL and two ELs, that's EL1 and EL2. EL1 only depends on the BL. And EL2 depends on the BL and EL1 at the same time. That's, EL2 data decoding may be implemented only after the BL and EL1 data are correctly received and decoded. Thus, the dependency relation between the BL and the EL also needs to consider the hierarchical relation between different ELs.

In order to describe the dependency relation between the BL and the EL of a scalable video service, an additional information element (IE) is introduced in the session start request information transmitted from a BMSC, and the information element may be named as LinkedTMGI, and it is used for indicating on which other MBMS service sessions the current MBMS service session depends. The LinkedTMGI indicates the TMGI list of all MBMS services on which the current MBMS service session depends.

The LinkedTMGI information element is optional in the MBMS session start request. E.g. when the MBMS service is a BL data service, the LinkedTMGI IE will not appear in the MBMS session start request signaling. For the EL data service, the LinkedTMGI IE in the MBMS session start request signaling will be assigned with the TMGI value of the BL and all ELs on which the EL data service depends.

If a scalable video service has multiple EL data services, and these EL data services only depends on the BL data service, then for each EL data service, the LinkedTMGI values are the same in their MBMS session start request signaling. If the LinkedTMGI value is set, the value will be transmitted from a BMSC to an eNodeB, and be saved by each network devices along the transmission path to be used for managing bearer management of the scalable video service. E.g. these network devices will comprise the dependency relation and the session start state table which are used for describing the dependency relation between the BL and the EL MBMS service and whether the related session start is successful or unsuccessful state.

The following table 1 is an example showing the dependency relation between the BL and the EL in each network device and the status of session start.

TABLE 1
dependency relation and status of session start

| MBMS service | LinkedTMGI | Start Successful or not |
|---|---|---|
| TMGI 1 | | Yes |
| TMGI 2 | TMGI 1 | Yes |
| TMGI 3 | TMGI 1, | No |
| | TMGI 2 | |
| TMGI 4 | TMGI 1, | No |
| | TMGI 2, | |
| | TMGI 3 | |
| TMGI 5 | | No |

Table 1 shows five MBMS services. Wherein, service 1 (TMGI1) is a BL MBMS service. Service 1 has three linked EL MBMS services: service 2 (TMGI2), service 3 (TMGI3) and service 4 (TMGI4). Some EL MBMS services only depend on the BL MBMS service, such as that service 2 (TMGI2) only depends on service 1 (TMGI 1). While some services not only depend on the BL service, but also the EL MBMS service, such as service 3 (TMGI3) depends on service 1 (BL MBMS service) and EL MBMS service 2 (TMGI). Service 4 (TMGI4) depends on service 1 (BL MBMS service) and another two EL MBMS services (TMGI2, TMGI3). Another service 5 (TMGI5) has no linked EL MBMS service. Each service has an indicator to indicate whether the session start of the service is successful or not. “Start successful or not” is used to indicate the session start result of each current MBMS service in the network device.

Since the network device of each level has the possibility that the MBMS session start procedure is established unsuccessfully, thus, in order to reduce the impact of a network device failing in establishing a MBMS session start procedure to other network devices establishing a MBMS session process in the service area, for a scalable video service the bearer management function should be included in each network device.

Thus, the MBMS bearer management function for the network device of each level is proposed to control the MBMS bearer establishing/release process, according to the dependency relation of the BL/EL MBMS service.

Firstly, in an embodiment, the MBMS bearer establishment via the MBMS session start procedure is described first.

The main principle is that, for a scalable video service, the BL MBMS service bearer should be successfully established first. Otherwise, the subsequent establishment of the related EL MBMS service bearer is useless. For an EL MBMS service, if all MBMS services (including the BL MBMS service, and possible EL MBMS service, such as TMGI 2 in table 1 only depends on the BL, and TMGI 3 and 4 depend on the BL and other EL) on which the EL MBMS service depends are established unsuccessfully, the EL MBMS service can not implement the session start procedure.

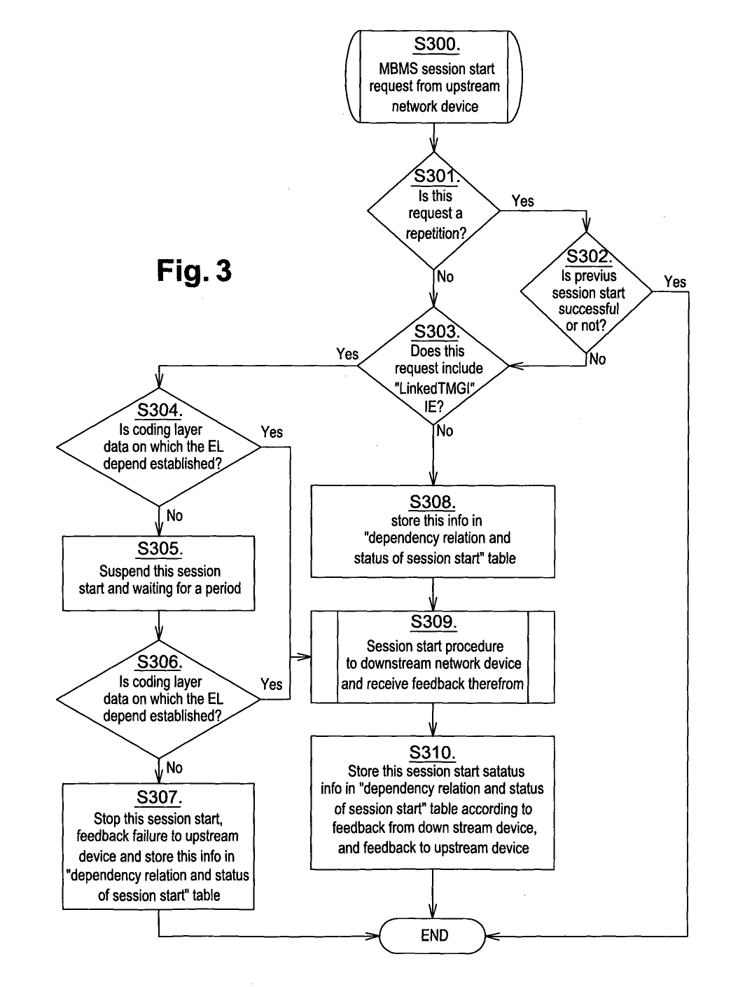

FIG. 3 shows the flow chart managing the MBMS bearer establishment of a scalable video service in the network device of each level.

Network devices comprise a multimedia broadcast multicast service gateway, a mobility management entity or a multicast coordination entity. According to the topology of wireless communication network, those skilled in the art may understand that, the upstream network device of the multimedia broadcast multicast service gateway is a broadcast multicast service center, and the downstream network device of the multimedia broadcast multicast service gateway is a mobility management entity. The upstream network device of the mobility management entity is a multimedia broadcast multicast service gateway, and the downstream network device of the mobility management entity is a multicast coordination entity. The upstream network device of the multicast coordination entity is a mobility management entity, and the downstream network device of the multicast coordination entity is a base station.

Firstly, in the step S300, each network device obtains the MBMS session start request signaling from an upstream network device.

Then, in the step S301, the network device determines whether the MBMS session start request signaling is a repetitive request. In detail, the network device may inquire “the dependency relationship and the session start procedure status” table, and determine whether it's a repeat of the initiated session start procedure and whether the MBMS bearer process is successfully established, according to the TMGI.

Next, in the step S302, if last MBMS bearer is successfully established, repeating the MBMS session start procedure is prevented. Referring to FIG. 2, when the MBMS session start is unsuccessfully established in an eNodeB, the upstream MCE may retransmit the MBMS session start request signaling to all eNodesBs administered by the MCE. Those skilled in the art may understand that, multiple eNodesBs administered by the same MCE may establish the same MBMS sessions, and have the same TMGI identifiers. At this time, the eNodesB administered by the MCE may determine whether the MBMS bearer identified by the TMGI is successfully established before via the TMGI. If the TMGI value is the same with the TMGI of a successfully established bearer, it means that there's no need to reestablish the MBMS bearer; otherwise, the MBMS bearer is reestablished. Certainly, if not considering that the MBMS session start procedure is repeated, the above steps S301 and S302 may be omitted.

Then, in the step S303, the network device determines whether the MBMS session start request signaling includes the “LinkedTMGI”IE.

If the MBMS session start request signaling doesn't include the “LinkedTMGI”IE, it means that the MBMS service is a BL MBMS service. Then in the step S308, the network device stores the information in the dependency relation list, and identifies the MBMS service as a BL service.

Next, in the step S309, the network device forwards the MBMS session start request signaling to the downstream network device, and receives the feedback from the downstream network device.

Then, in the step S310, the network device identifies whether the session start is successfully established in its dependency relation and status of session start table, according to the feedback to the MBMS session start request signaling from the downstream network device.

If the MBMS session start request signaling includes the “LinkedTMGI”IE, it means that the MBMS service is a EL MBMS service, and its LinkedTMGI indicates the BL MBMS service and possible EL MBMS service on which the EL MBMS service depends. Then in the step S304, the network device needs to look up “the dependency relation and status of session start” table of the network device, to determine whether the BL MBMS service and possible EL MBMS service on which the EL MBMS service depends are established successfully.

If the BL MBMS service and possible EL MBMS service on which the EL MBMS service depends are established successfully, the method goes into the step S309: the network device may continue implementing the EL MBMS session start procedure. That is, the network device continues transmitting the session start signaling to a downstream network device, and waits for the feedback from the downstream network device.

Then, the method goes into the step S310, the network device stores or updates “the dependency relation and status of session start” table, according to actual state.

Otherwise, if the BL MBMS service and possible EL MBMS service on which the EL MBMS service depends are established unsuccessfully, the method goes into the step S305, the network device needs to suspend establishing a bearer, and the network device needs to wait for a predetermined time, then implements determination again.

If the result is still that the BL MBMS service and possible EL MBMS service on which the EL MBMS service depends are established unsuccessfully, the method goes into the step S307, the network device may directly feed back to the upstream network device of the network device the failure of the MBMS service bearer of the network device.

If after waiting for the predetermined time, the network device implements determination again: if the BL MBMS service on which the EL MBMS service depends and possible EL MBMS service are established successfully, the method goes into the step S309, the network device may continue implementing the EL MBMS session start procedure. Next, in the step S310, the network device stores or updates “the dependency relation and status of session start” table, according to actual state.

The BMSC will uniformly manage the status of the BL MBMS service and the EL MBMS service, and will determine how to deal with the failure of the session start procedure according to the policy and strategy of operators. E.g. restarting the session start procedure with the same TMGI, or ignoring these downstream network devices, that is, not providing scalable video services to these areas.

For the eNodeB and the BMSC, as a terminal point of the session start procedure, there are some differences for the eNodeB and the BMSC to the bearer management process of a scalable video service and other intermediate network devices. The eNodeB is a termination network device of the session start procedure. The eNodeB has no downstream network devices. If the eNodeB determines the session start procedure is failure, the eNodeB only maintains or updates “the dependency relation and status of session start” table, and feeds back the failure to the upstream MCE. On the other hand, as the initiator of the session start procedure, since the BMSC has no upstream network devices, thus the BMSC only receives the feedback from downstream network devices.

### The Second Embodiment

### the MBMS Bearer Release Via the MBMS Session Stop Procedure

There's no failure process in implementing the MBMS bearer release for a scalable video service, and the release process is successful by default. But according to the dependency relation between the BL MBMS service and the EL MBMS service, it still may optimize the release of the MBMS bearer service related to the scalable video service, to reduce the signaling process and processing time.

The MBMS session stop procedure is controlled by the BMSC. The following will describe two embodiments in which the BMSC initiates the session stop procedure to release the MBMS bearer resource.

### Embodiment 1

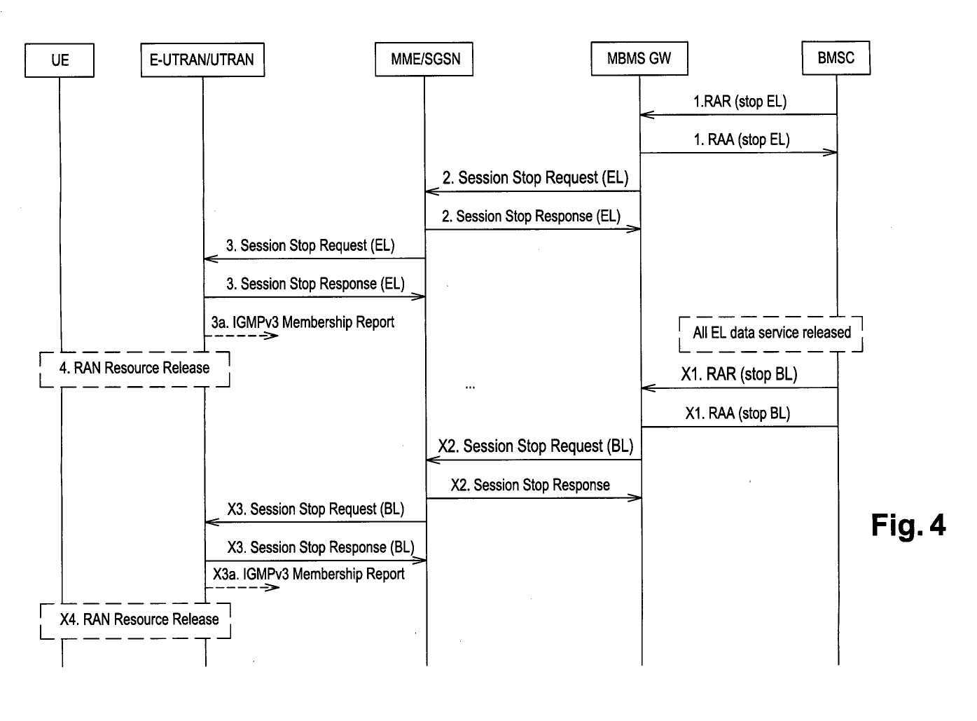

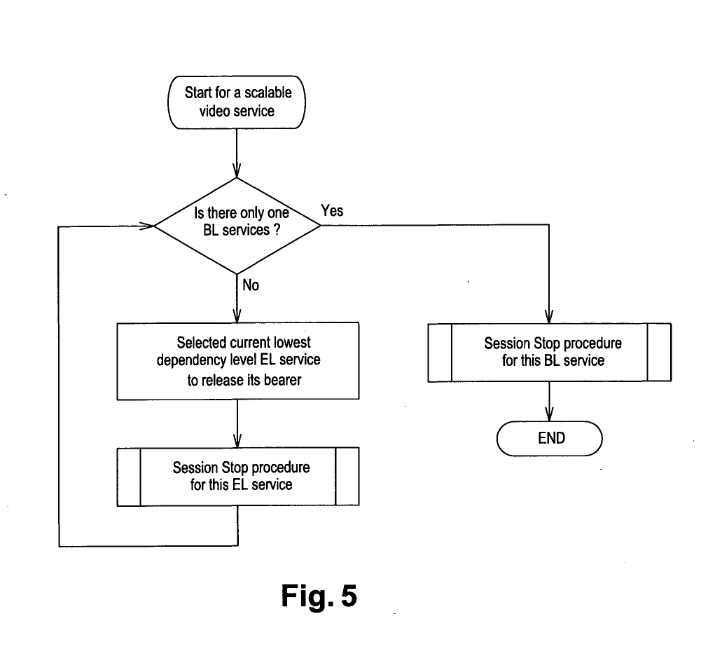

In the service transmission phase, the BMSC needs to dynamically adjust the video quality and stop some EL data service transmission until stop all video data service. This solution gradually decreases the video quality until the video service is finally terminated. In the condition, considering the dependency relation between the BL and the EL data in the decoding process, if the BL data can't be obtained, the EL data is useless, even if the EL data is received correctly. Thus, in order to ensure the data effectiveness and resource utilization efficiency, it should obey the following order for the MBMS bearer release process of a scalable video service: the BMSC should ensure that when initiating the session stop procedure of the MBMS bearer release for the BL data service, all EL bearers depending on the BL are released. When all EL data services complete the session stop procedure, the BMSC may initiate the session stop procedure for the BL data service to release the MBMS bearer of the BL data service. The MBMS bearer release for different ELs is also similar. That is, after the MBMS bearer of all other EL data services depending on an EL data service are released, then the EL MBMS bearer is released. Thus, the EL data service with the lowest dependency level (i.e. the EL on which no other ELs depends) is released first each time. Thus, the session stop request signaling transmitted from the BMSC includes the BL or EL TMGI needing to be stopped. The intermediate network device receiving the session stop request signaling (comprising MME/SGSN, MCE), and the terminal eNodeB stops the corresponding BL/EL session process according to the TMGI in the session stop request signaling, that's, releasing the corresponding MBMS resource. FIG. 4 and FIG. 5 show the related signaling process of the MBMS bearer release of managing scalable coding video in a BMSC.

### Embodiment 2

Another embodiment of the scalable video service transmission is to stop immediately all data transmission of the scalable video service. The BMSC needs to initiate the session stop procedure to release the related resource of all the scalable video services comprising the BL and the EL data service. In the condition, considering the dependency relation between the BL data service and the EL data service, only one MBMS session stop procedure directing to the BL data service may be initiated. Then, all downstream network devices receiving the session stop request signaling not only stop the BL data service session, but also stop all EL data service session depending on the BL.

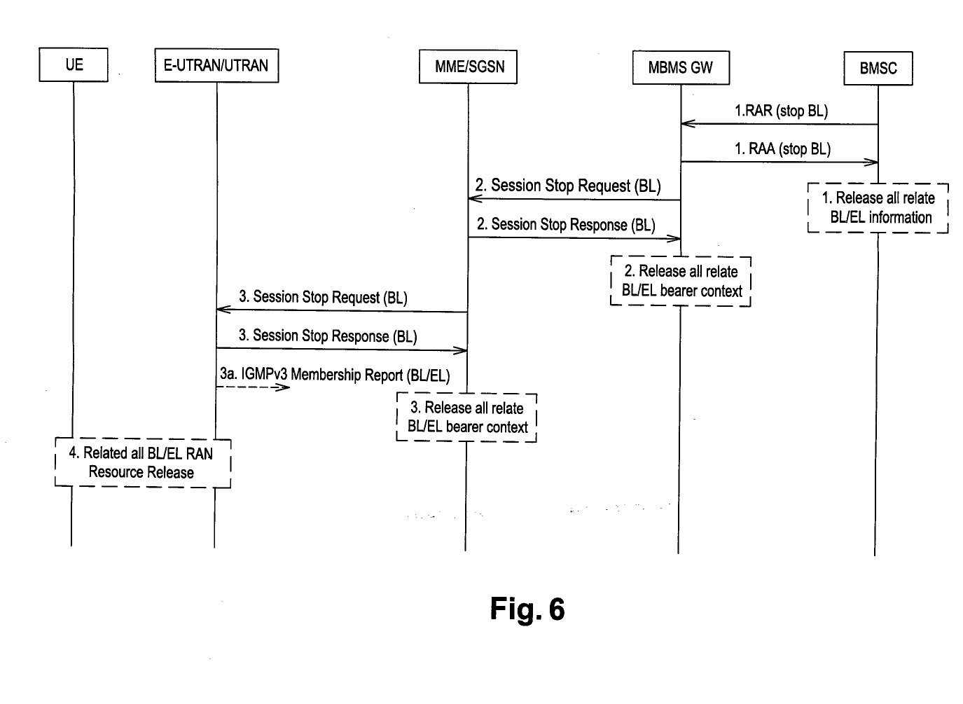

The solution may greatly reduce the signaling interaction between the BMSC and the eNodeB, since the BMSC only initiates one BL data service session stop procedure, but all EL data services depending on the BL are also stopped. The related signaling process and basic process of the embodiment are shown in FIG. 6.

Firstly, the BMSC transmits the session stop request (the request includes the TMGI value of the BL needing to be stopped) to the MBMS GW.

Then, the MBMS GW transmits the session stop response to the BMSC.

Next, the BMSC releases all related BL/EL information.

Then, the MBMS GW transmits the session stop request (the request includes the TMGI value of the BL needing to be stopped) to the MME or SGSN.

Next, the MME or SGSN transmits the session stop response to the MBMS GW.

Then, the MBMS GW releases all related BL/EL bearer contexts.

Next, the MME or SGSN transmits the session stop request (the request includes the TMGI value of the BL needing to be stopped) to the E-UTRAN or UTRAN.

Then, the E-UTRAN or UTRAN transmits the session stop response to the MME or SGSN.

Next, the E-UTRAN or UTRAN releases all related BL/EL bearer contexts.

And the E-UTRAN or UTRAN transmits the IGMP group report message to the MME or SGSN.

Then, the E-UTRAN or UTRAN interacts with the UE, thus releases all related BL/EL radio access network resources.

It may be understood that embodiments of the invention are also applicable for the wireless video service based on scalable coding in the UMTS MBMS architecture.

The above describes the invention from the method perspective. The following will describe the invention from the apparatus perspective.

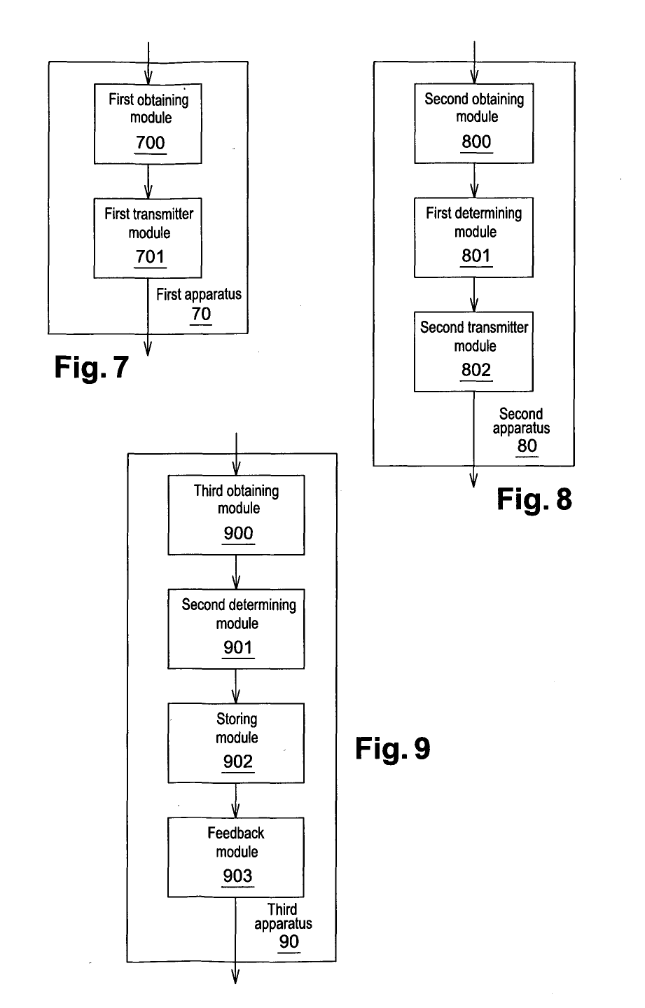

FIG. 7 shows the block diagram of the first apparatus according to an embodiment of the invention. The first apparatus 70 is in the BMSC, and is used for managing video service transmission. The video service is coded as base coding layer data and enhancement coding layer data, the base coding layer data and the enhancement coding layer data respectively use different multimedia broadcast multicast service bearer to implement transmission, and the first apparatus 70 comprises the following modules: the first obtaining module 700 and the first transmitter module 701.

Firstly, the first obtaining module 700 obtains dependency information of the enhancement coding layer data, the dependency information being used to indicate the coding layer data on which the enhancement coding layer data depends.

Then the first transmitter module 701 transmits to a multimedia broadcast multicast service gateway a session start request signaling of multimedia broadcast multicast service, the session start request signaling of multimedia broadcast multicast service being used to request establishing multimedia broadcast multicast service bearer for the enhancement coding layer data, and the session start request signaling of multimedia broadcast multicast service including the dependency information.

FIG. 8 shows the block diagram of the second apparatus according to an embodiment of the invention.

The second apparatus 80 is in the network device, and is used for managing video service transmission. The video service is coded as base coding layer data and enhancement coding layer data, and the second apparatus comprises the following modules: the second obtaining module 800, the first determining module 801 and the second transmitter module 802.

Firstly, the second obtaining module 800 is used for obtaining a first session start request signaling of multimedia broadcast multicast service from an upstream network device, the first session start request signaling of multimedia broadcast multicast service being used to request establishing multimedia broadcast multicast service bearer for the enhancement coding layer data, the first session start request signaling of the multimedia broadcast multicast service including dependency information, and the dependency information being used to indicate the coding layer data on which the enhancement coding layer data depends.

Then, the first determining module 801 is used for determining whether the multimedia broadcast multicast service bearer for the coding layer data on which the enhancement coding layer data depends is successfully established.

Next, when the multimedia broadcast multicast service bearer for the coding layer data on which the enhancement coding layer data depends is successfully established, the second transmitter module 802 forwards the first session start request signaling of multimedia broadcast multicast service to a downstream network device of the network device.

When the multimedia broadcast multicast service bearer for the coding layer data on which the enhancement coding layer data depends is not successfully established, the second transmitter module 802 suspends forwarding the first session start request signaling of multimedia broadcast multicast service to the downstream network device.

FIG. 9 shows the block diagram of the third apparatus according to an embodiment of the invention. The third apparatus 90 is in a base station, and is used for managing video service transmission. The video service is coded as base coding layer data and enhancement coding layer data, and the third apparatus 90 comprises the following modules: the third obtaining module 900, the second determining module 901, the storing module 902 and the feedback module 903.

Firstly, the third obtaining module 900 obtains a first session start request signaling of multimedia broadcast multicast service from a multicast coordination entity, the first session start request signaling of multimedia broadcast multicast service being used to request establishing multimedia broadcast multicast service bearer for the enhancement coding layer data, the first session start request signaling of multimedia broadcast multicast service including dependency information, and the dependency information being used to indicate the coding layer data on which the enhancement coding layer data depends;

Then, the second determining module 901 determines whether the multimedia broadcast multicast service bearer for the coding layer data on which the enhancement coding layer data depends is successfully established.

Next, the storing module 902 stores identification information that the multimedia broadcast multicast service bearer for the enhancement coding layer data is successfully established, when the multimedia broadcast multicast service bearer for the coding layer data on which the enhancement coding layer data depends is successfully established.

when the multimedia broadcast multicast service bearer for the coding layer data on which the enhancement coding layer data depends is not successfully established, the storing module 902 stores the identification information that the multimedia broadcast multicast service bearer for the enhancement coding layer data is not successfully established; and the third apparatus further includes the feedback module 903, which is used for transmitting a feedback of unsuccessfully establishing the multimedia broadcast multicast service bearer for the enhancement coding layer data, to the multicast coordination entity.

The above describes the embodiments of the invention, but the invention is not limited to the specific system, device and detailed protocol, those skilled in the art may make various deforms or modifications within the scope of the appended claims.

Those ordinary skilled in the art may understand and implement other changes to the disclosed embodiments, by studying the specification, disclosure, drawings and the appended claims. In the claims, the word “comprise” doesn't exclude other components and steps, and the word “one” doesn't exclude plural. In the invention, “first”, “second” only represent a name, not a sequential relation. In the actual application of the invention, a component may implement the function of multiple technical features quoted by the claims. Any reference signs in the claims shouldn't be understood as a limitation to the scope.

1. A method used for managing video service transmission in a broadcast multicast service center, wherein the video service is coded as base coding layer data and enhancement coding layer data, the base coding layer data and the enhancement coding layer data respectively use different multimedia broadcast multicast service bearer to implement transmission, and the method comprises:
obtaining dependency information of the enhancement coding layer data, the dependency information being used to indicate the coding layer data on which the enhancement coding layer data depends; and
transmitting to a multimedia broadcast multicast service gateway a session start request signaling of multimedia broadcast multicast service, the session start request signaling of multimedia broadcast multicast service being used to request establishing multimedia broadcast multicast service bearer for the enhancement coding layer data, the session start request signaling of multimedia broadcast multicast service including the dependency information.

2. A method of claim 1, wherein the session start request signaling of multimedia broadcast multicast service includes a first temporary mobile organization identification, and after the transmitting the method further comprises:
receiving a feedback of unsuccessfully establishing the multimedia broadcast multicast service bearer for the enhancement coding layer data, transmitted by the multimedia broadcast multicast service gateway;
retransmitting to the multimedia broadcast multicast service gateway the session start request signaling of multimedia broadcast multicast service, the temporary mobile organization identification of the retransmitted session start request signaling of multimedia broadcast multicast service being the same with the first temporary mobile organization identification.

3. A method of claim 1, wherein the coding layer data on which the enhancement coding layer data depends comprises any one of the following:
the base coding layer data; or
the base coding layer data and at least one enhancement coding layer data.

4. A method of claim 1, wherein the broadcast multicast service center is for obtaining the dependency information of multiple enhancement coding layer data, and after the transmitting the method further comprises:
determining whether it needs to stop the video service gradually, or to stop the video service immediately;
when needing to stop the video service gradually, according to the dependency relation of the multiple enhancement coding layer data, sequentially transmitting to the multiple enhancement coding layer data a first session stop request signaling of multimedia broadcast multicast service,
once transmitting for all enhancement coding layer data the session stop request signaling of multimedia broadcast multicast service, transmitting for the base coding layer data a second session stop request signaling of multimedia broadcast multicast service;
when needing to stop the video service immediately, transmitting to the multimedia broadcast multicast service gateway a third session stop request signaling of multimedia broadcast multicast service, the third session stop request signaling of multimedia broadcast multicast service is used to request releasing the multimedia broadcast multicast service bearer for the base coding layer data and all enhancement coding layer data depending on the base coding layer data.

5. A method used for managing video service transmission in a network device, wherein the video service is coded as base coding layer data and enhancement coding layer data, and the method comprises:
obtaining a first session start request signaling of multimedia broadcast multicast service from an upstream network device, the first session start request signaling of the multimedia broadcast multicast service being used to request establishing multimedia broadcast multicast service bearer for the enhancement coding layer data, the first session start request signaling of multimedia broadcast multicast service including dependency information, and the dependency information being used to indicate the coding layer data on which the enhancement coding layer data depends;
determining whether the multimedia broadcast multicast service bearer, for the coding layer data on which the enhancement coding layer data depends, is successfully established; and
when the multimedia broadcast multicast service bearer for the coding layer data on which the enhancement coding layer data depends is successfully established, forwarding the first session start request signaling of multimedia broadcast multicast service to a downstream network device of the network device;
when the multimedia broadcast multicast service bearer for the coding layer data on which the enhancement coding layer data depends is not successfully established, suspending forwarding the first session start request signaling of multimedia broadcast multicast service to the downstream network device.

6. A method of claim 5, wherein after the suspending the method further comprises:
storing identification information about whether the multimedia broadcast multicast service bearer for the enhancement coding layer data is successfully established, and storing the dependency relation of the enhancement coding layer data.

7. A method of claim 5, further comprising: when the multimedia broadcast multicast service bearer for the enhancement coding layer data is not successfully established, transmitting a feedback of unsuccessfully establishing the multimedia broadcast multicast service bearer for the enhancement coding layer data, to the upstream network device of the network device.

8. A method of claim 5, wherein the coding layer data on which the enhancement coding layer data depends comprises any one of the following items:
the base coding layer data; or
the base coding layer data and at least one enhancement coding layer data.

9. A method of claim 5, wherein after the forwarding the method further comprises:
receiving a third session stop request signaling of multimedia broadcast multicast service from the upstream network device, the third session stop request signaling of multimedia broadcast multicast service being used to request releasing the multimedia broadcast multicast service bearer for the base coding layer data and all enhancement coding layer data depending on the base coding layer data;
according to the third session stop request signaling of multimedia broadcast multicast service, releasing the multimedia broadcast multicast service bearer corresponding to the base coding layer data in the network device, and releasing the multimedia broadcast multicast service bearer of all enhancement coding layer data depending on the base coding layer data; and
forwarding the third session stop request signaling of multimedia broadcast multicast service to the downstream network device.

10. A method of claim 5, wherein the network devices comprise a multimedia broadcast multicast service gateway, a mobility management entity or a multicast coordination entity.

11. A method used for managing video service transmission in a base station, wherein the video service is coded as base coding layer data and enhancement coding layer data, and the method comprises:
obtaining a first session start request signaling of multimedia broadcast multicast service from a multicast coordination entity, the first session start request signaling of multimedia broadcast multicast service being used to request establishing multimedia broadcast multicast service bearer for the enhancement coding layer data, the first session start request signaling of multimedia broadcast multicast service including dependency information, and the dependency information being used to indicate the coding layer data on which the enhancement coding layer data depends;
determining whether the multimedia broadcast multicast service bearer for the coding layer data on which the enhancement coding layer data depends is successfully established; and
when the multimedia broadcast multicast service bearer for the coding layer data on which the enhancement coding layer data depends is successfully, storing identification information that the multimedia broadcast multicast service bearer for the enhancement coding layer data is successfully established;
when the multimedia broadcast multicast service bearer for the coding layer data on which the enhancement coding layer data depends is not successfully established, storing identification information that the multimedia broadcast multicast service bearing for the enhancement coding layer data is not successfully established; and transmitting to the multicast coordination entity a feedback of unsuccessfully establishing the multimedia broadcast multicast service bearer for the enhancement coding layer data.

12. A method of claim 11, wherein the coding layer data on which the enhancement coding layer data depends comprises any one of the following:
the base coding layer data; or
the base coding layer data and at least one enhancement coding layer data.

13. A method of claim 11, wherein, after the storing the method further comprises:
receiving a third session stop request signaling of multimedia broadcast multicast service from the multicast coordination entity, the third session stop request signaling of multimedia broadcast multicast service is used to request releasing the multimedia broadcast multicast service bearer for the base coding layer data and all enhancement coding layer data depending on the base coding layer data;
according to the third session stop request signaling of multimedia broadcast multicast service, releasing the multimedia broadcast multicast service bearer corresponding to the base coding layer data in the base station, and releasing the multimedia broadcast multicast service bearer of all enhancement coding layer data depending on the base coding layer data.

14. A first apparatus used for managing video service transmission in a broadcast multicast service center, wherein the video service is coded as base coding layer data and enhancement coding layer data, the base coding layer data and the enhancement coding layer data respectively use different multimedia broadcast multicast service bearer to implement transmission, and the first apparatus comprises the following modules:
a first obtaining module, used for obtaining dependency information of the enhancement coding layer data, the dependency information being used to indicate the coding layer data on which the enhancement coding layer data depends; and
a first transmitter module, used for transmitting to a multimedia broadcast multicast service gateway a session start request signaling of multimedia broadcast multicast service, the session start request signaling of multimedia broadcast multicast service being used to request establishing multimedia broadcast multicast service bearer for the enhancement coding layer data, and the session start request signaling of multimedia broadcast multicast service including the dependency information.

15. A second apparatus used for managing video service transmission in a network device, wherein the video service is coded as base coding layer data and enhancement coding layer data, and the second apparatus comprises the following modules:
a second obtaining module, used for obtaining a first session start request signaling of multimedia broadcast multicast service from an upstream network device, the first session start request signaling of multimedia broadcast multicast service being used to request establishing multimedia broadcast multicast service bearer for the enhancement coding layer data, the first session start request signaling of the multimedia broadcast multicast service including dependency information, and the dependency information being used to indicate the coding layer data on which the enhancement coding layer data depends;
a first determining module, used for determining whether the multimedia broadcast multicast service bearer for the coding layer data on which the enhancement coding layer data depends is successfully established; and
a second transmitter module, used for, when the multimedia broadcast multicast service bearer for the coding layer data on which the enhancement coding layer data depends is successfully established, forwarding the first session start request signaling of multimedia broadcast multicast service to a downstream network device of the network device; and
when the multimedia broadcast multicast service bearer for the coding layer data on which the enhancement coding layer data depends is not successfully established, the second transmitter module is for suspending forwarding the first session start request signaling of multimedia broadcast multicast service to the downstream network device.

16. (canceled)
